(19) United States
(12) Patent Application Publication
(10) Pub. No.: US 2026/0365826 A1
(43) Pub. Date: Nov. 19, 2026

(54) FLAME RETARDANT THERMOPLASTIC POLYURETHANE COMPOSITION

(71) Applicant: BASF SE, Ludwigshafen Am Rhein (DE)

(72) Inventors: De Hui YIN, Shanghai (CN); Da Hai YU, Shanghai (CN); Qing Huai TANG, Shanghai (CN); Qiang PANG, Shanghai (CN); Oliver Steffen HENZE, Lemfoerde (DE)

(73) Assignee: BASF SE, Ludwigshafen Am Rhein (DE)

(21) Appl. No.: 19/111,856

(22) PCT Filed: Sep. 4, 2023
(86) PCT No.: PCT/EP2023/074111

§ 371 Date: Mar. 14, 2025

(30) Foreign Application Priority Data
Sep. 15, 2022 (WO) PCT/CN2022/119049

(51) Int. Cl. C08K 5/5313; C08K 5/523

(52) U.S. Cl. CPC C08K 5/5313; C08K 5/523

(57) ABSTRACT

Disclosed is a thermoplastic polyurethane composition comprising, based on a total weight of the thermoplastic polyurethane composition, 84-97 wt. % of a thermoplastic polyurethane, and 3-16 wt. % of a flame retardant, wherein the flame retardant comprises an ionic liquid and a phosphorus-containing ester. Also provided are an article produced from the thermoplastic polyurethane composition, and its use.

### TECHNICAL FIELD

The present disclosure relates to a flame retardant thermoplastic polyurethane composition, an article produced from the same, and the use of the article.

### BACKGROUND

Thermoplastic polyurethane (TPU) is suitable for many applications, for example wires, cables, pipelines, etc. As TPU per se is combustible, flame retardant TPU is highly desired in scenarios, such as those in aircrafts, electric vehicles, appliances, buildings, and constructions.

Traditional flame retardant TPUs usually incorporate nitrogen or phosphorus-based flame retardants, such as, melamine cyanurate, ammonium polyphosphate, aluminum hypophosphite, cresyl diphenyl phosphate. One of the issues with these flame retardants is the poor improvement of flame retardancy. To reach UL 94 V0 rating, a dosage of about 20-30 wt. % of the flame retardants is needed. Such high dosage will impact the compatibility and mechanical strength of the TPU composition. Additionally, high usage of flame retardants also increases the production costs.

Ionic liquids as flame retardants have been reported. However, they also deteriorate the mechanical properties of the TPU matrix.

CN111909503A describes a thermoplastic polyurethane composition containing 3 wt. % of tributylmethylammonium tributyl phosphate. Tensile strength decreases by 20% and 30% for polyether and polyester polyurethanes, respectively.

US20150353832A1 teaches use of phosphinate ionic liquids as flame retardants and as a melt viscosity reduction agent for polymer processing at the same time.

CN105440652A discloses a flame-retardant thermoplastic polyurethane elastomer with an intumescent flame retardant and an ionic liquid. The ionic liquid is preferably a dialkylimidazolium ionic liquid, such as 1-ethyl-3-methylimidazolium hexafluorophosphate. The intumescent flame retardant includes aluminum hypophosphite, ammonium polyphosphate, aluminum diethylphosphinate, etc.

Still, flame-retardant thermoplastic polyurethane compositions with low dosage of flame retardants and good mechanical strength are desired.

### SUMMARY

An objective of the present disclosure is to overcome the problems of the prior art discussed above and to provide a flame-retardant thermoplastic polyurethane composition that requires low addition of flame retardants while maintaining physical properties such as tensile strength, abrasion loss, elongation at break, etc.

Surprisingly, it has been found by the inventors that the above object can be achieved by a thermoplastic polyurethane composition comprising, based on a total weight of the thermoplastic polyurethane composition, 84-97 wt. % of a thermoplastic polyurethane, and 3-16 wt. % of a flame retardant, wherein the flame retardant comprises an ionic liquid and a phosphorus-containing ester.

According to another aspect of the present disclosure, provided is an article produced from the thermoplastic polyurethane composition.

A further aspect of the present disclosure provides a use of the article.

It has been surprisingly found in this application that, by incorporating the phosphorus-containing ester and the ionic liquid in the thermoplastic polyurethane composition, the polyurethane composition shows good flame retardancy, and, at the same time, good mechanical properties.

### DETAILED DESCRIPTION

Unless defined otherwise, all technical and scientific terms used herein have the meaning commonly understood by a person skilled in the art to which the present disclosure belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

Unless otherwise identified, all percentages (%) are “percent by weight”.

Here, phosphorus-containing esters refer to a class of organophosphorus compounds including organophosphate, organophosphonate, or organophosphinate.

Organophosphates are a class of organophosphorus compounds with the general structure O═P(OH)₂(OR), O═P(OH)(OR)₂, O═P(OR)₃, wherein R is an alkyl or aryl group, a central phosphate molecule with alkyl or aromatic substituents. Exemplary organophosphates include triethyl phosphate, triphenyl phosphate.

Organophosphonates are organophosphorus compounds containing C—PO(OH)₂, C—PO(OH)(OR) or C—PO(OR)₂ groups, wherein R is an alkyl or aryl group.

Organophosphinates are organophosphorus compounds containing the following group:

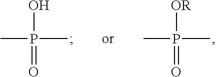

wherein R is an alkyl or aryl group.

Unless otherwise identified, the temperature refers to room temperature and the pressure refers to ambient pressure.

Unless otherwise identified, the term ionic liquid refers to a salt whose melting point is below 100 °C.

According to the present disclosure, provided is a thermoplastic polyurethane composition comprising, based on a total weight of the thermoplastic polyurethane composition,
84-97 wt. % of a thermoplastic polyurethane, and
3-16 wt. % of a flame retardant,
wherein the flame retardant comprises an ionic liquid and a phosphorus-containing ester.

Preferably, a sheet of a thickness of 2 mm prepared from the thermoplastic polyurethane composition achieves a UL94 V0 rating, following procedures of Underwriter's Laboratory Bulletin 94 entitled “Tests for Flammability of Plastic Materials, UL94”.

### Flame Retardants

The flame retardant according to the present disclosure include an ionic liquid and a phosphorus-containing ester. It has been discovered that the simultaneous use of the ionic liquid and the phosphorus-containing ester can enhance the flame retardancy and thus reduce the total dosage of the flame retardants needed. As a result of reduction in dosage of flame retardants, the deterioration of mechanical properties of thermoplastic polyurethane composition could be mitigated.

Preferably, the ionic liquid is a phosphorus-based ionic liquid. More preferably, the ionic liquid has a formula of:

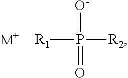

wherein M⁺ represents a monovalent cation selected from the group consisting of an ammonium, a quaternary ammonium, an imidazolium, a guanidinium, a pyridinium, a pyridazinium, 1,2,4-triazolium, a triazine, a sulfonium, a phosphazenium and a phosphonium cation. Preferably, M⁺ represents a phosphonium cation. More preferably, M⁺ represents a quaternary alkylphosphonium or a quaternary arylphosphonium.
R₁ and R₂ are each independently selected from hydrogen, hydroxy, C1-C18 alkyl, aryl, C1-C18 alkoxyl, aryl, (C3-C10) heterocyclyl, (C3-C10)cycloalkyl, (C3-C10)heterocyclyl (C1-C8)alkyl, aryl (C1-C8)alkyl, heteroaryl and heteroaryl (C1-C8)alkyl group, each of which is unsubstituted or substituted with one or two halogen atoms, —NO₂, —CF₃, —OCF₃, —OCH₃, —CO₂H, —NH₂, —OH, —SH, —NHCH₃, —N(CH₃)₂, —CN, —SCH₃, —SO₃H, —CH═CH—CH₂—CH═CH₂, —P((C1-C5) alkyl)₂, and —P(O)(OEt)₂, or mixtures of the substituents.

Preferably, the ionic liquid has a weight percentage of 0.2-2.8 wt. %, preferably 0.3-1.5 wt. %, more preferably 0.5-1.0 wt. %, based on a total weight of the thermoplastic polyurethane composition.

The phosphorus-containing ester includes one or more organophosphate, organophosphonate, organophosphinate. Phosphorus-containing ester preferably includes one or more selected from trialkyl phosphates, triaryl phosphates, halogenated phosphates, and organophosphonates. More preferably, phosphorus-containing ester includes one or more selected from resorcinol bis(diphenylphosphate) (shortened as “RDP”), bisphenol A bis(diphenyl phosphate) (shortened as “BDP”), cresyl diphenyl phosphate (shortened as “CDP”), monomeric resorcinol dixylenyl phosphate, polymeric resorcinol dixylenyl phosphate, trixylenyl phosphate, triethyl phosphate (TEP), tricresyl phosphate, triphenyl phosphate, tris(1-chloro-2-propyl) phosphate (TCPP) and tris(2-chloroethyl) phosphate (TCEP), dimethyl methylphosphonate (DMMP), and dimethyl propane phosphonate (DMPP).

Preferably, the phosphorus-containing ester has a weight percentage of 1-18 wt. %, more preferably 2-15 wt. %, still more preferably 3-10 wt. %, based on a total weight of the thermoplastic polyurethane composition.

The ionic liquid and the phosphorus-containing ester preferably are in a weight ratio of 1:100-1:0.7, preferably 1:50-1:2, more preferably 1:20-1:5. Under the preferred weight ratio, the overall dosage of the two kinds of flame retardants can be reduced, while the mechanical strength and other properties can be maintained or even enhanced.

Besides the ionic liquid and the phosphorus-containing ester, halogenated compounds, for example, halogenated polyols, as well as solids, such as diethyl aluminum hypophosphite, aluminum hypophosphite, aluminum trihydroxide, ammonium polyphosphate (APP), red phosphorus, expanded graphite and melamine are suitable as an auxiliary flame retardant.

The flame retardant may be added into the thermoplastic polyurethane during or after the synthesis in liquid state, masterbatch pellets, or powders if any powdery flame retardant is used as auxiliary flame retardant, via an extruder, a mixer, a miller, or the like.

The ionic liquid and the phosphorus-containing ester may be added into thermoplastic polyurethane composition simultaneously or separately. The ionic liquid may be pre-mixed with the phosphorus-containing ester to form a mixture of flame retardants.

### Thermoplastic Polyurethane

To prepare the thermoplastic polyurethane composition, a thermoplastic polyurethane is needed, which may be prepared beforehand, as in form of pellets, or in-situ synthesized. For example, the polyurethane may be synthesized by reacting a polyol component and an isocyanate component. In various embodiments, the polyol component comprises,
a polyether polyol, a polyester polyol or a mixture thereof; and
one or more chain extenders.

The isocyanate component may include one or more selected from monomeric, oligomeric, or polymeric isocyanates, prepolymers of isocyanates with active hydrogen containing compounds which are end-capped with isocyanate groups, or polymerized alkyl or aryl isocyanates.

Preferably, the thermoplastic polyurethane has a weight average molecular weight in the range from 50,000 to 500,000 Da.

Preferably, the thermoplastic polyurethane composition has a hardness of Shore 40 A to Shore 80 D, preferably Shore 50 A to Shore 98 A, as determined in accordance with DIN ISO 48-4.

### Polyol Component

The polyol component includes a polyether polyol, a polyester polyol or a mixture thereof and one or more chain extender.

Polyether polyols and polyester polyols are collectively known as polyols. Polyol refers to a polyhydroxy compound. Preferably, polyhydroxy compounds having a functionality of 1.9 to 2.1, and a hydroxyl number of 30 to 200 mg KOH/g are examples of higher molecular weight compounds having at least two reactive hydrogen atoms.

Suitable polyester polyols can be produced, for example, from organic dicarboxylic acids with 2 to 12 carbons, preferably aliphatic dicarboxylic acids with 4 to 6 carbons, and multivalent alcohols, preferably diols, with 2 to 12 carbons, preferably 2 to 6 carbons. Examples of dicarboxylic acids include succinic acid, glutaric acid, adipic acid, suberic acid, azelaic acid, sebacic acid, decanedicarboxylic acid, maleic acid, fumaric acid, phthalic acid, isophthalic acid, and terephthalic acid. The dicarboxylic acids can be used individually or in mixtures. Instead of the free dicarboxylic acids, the corresponding dicarboxylic acid derivatives may also be used such as dicarboxylic acid mono- or di-esters of alcohols with 1 to 4 carbons, or dicarboxylic acid anhydrides. Dicarboxylic acid mixtures of succinic acid, glutaric acid and adipic acid in quantity ratios of 20-35:35-50:20-32 parts by weight are preferred, especially adipic acid. Examples of divalent and multivalent alcohols, especially diols, include ethanediol, diethylene glycol, 1,2- and 1,3-propanediol, dipropylene glycol, 1,4-butanediol, 1,5-pentanediol, 1,6-hexanediol, 1,10-decanediol, 2-methyl-1,3-propanediol, 3-methyl-1,5-pentanediol, glycerin, and trimethylolpropane. Glycol, diethylene glycol, 1,4-butanediol, 1,5-pentanediol, 1,6-hexanediol, or mixtures of at least two of these diols are preferred, especially ethanediol, 1,4-butanediol, and 1,6-hexanediol.

The polyester polyols can be produced by polycondensation of organic polycarboxylic acids, e.g., aromatic or preferably aliphatic polycarboxylic acids and/or derivatives thereof and multivalent alcohols in the presence of catalysts or preferably in the presence of esterification catalysts, preferably in an atmosphere of inert gases, e.g., nitrogen, carbon dioxide, helium, argon, etc., in the melt at temperatures of 150 °C to 250 °C, preferably 180 °C to 220 °C, optionally under reduced pressure, up to the desired polymerization degree, which is preferably less than 20, especially less than 15. In a preferred embodiment, the esterification mixture is subjected to polycondensation at the temperatures mentioned above up to an acid value of less than 1 mg KOH/g, under normal pressure and then under a pressure of less than 500 mbar, preferably 50 to 150 mbar. Examples of suitable esterification catalysts include iron, cadmium, cobalt, lead, zinc, antimony, magnesium, titanium, and tin catalysts in the form of metals, metal oxides or metal salts. However, the polycondensation may also be per formed in liquid phase in the presence of diluents and/or entraining agents such as benzene, toluene, xylene, or chlorobenzene for azeotropic distillation of the water of condensation.

To produce the polyester polyols, the organic polycarboxylic acids and/or derivatives thereof and multi valent alcohols are preferably polycondensed in a mole ratio of 1:1-1.8, preferably 1:1.05-1.2.

The resulting polyester polyols preferably have a functionality of 1.9 to 2.1, and a hydroxyl number of 30 to 200 mg KOH/g.

Polyether polyols, which can be obtained by known methods, may also be used as the polyhydroxy compounds. For example, polyether polyols can be produced by anionic polymerization with alkali hydroxides such as sodium hydroxide or potassium hydroxide or alkali alcoholates, such as sodium methylate, sodium ethylate or potassium ethylate or potassium isopropylate as catalysts and with the addition of at least one initiator molecule containing 2 to 8, preferably 3 to 8, reactive hydrogens or by cationic polymerization with Lewis acids such as antimony pentachloride, boron trifluoride etherate, etc., or bleaching earth as catalysts from one or more alkylene oxides with 2 to 4 carbons in the alkylene radical.

Suitable cyclic ethers and alkylene oxides include, for example, tetrahydrofuran, 1,3-propylene oxide, 1,2- and 2,3-butylene oxide, styrene oxide, and preferably ethylene oxide and 1,2-propylene oxide. The alkylene cyclic ethers and oxides may be used individually, in alternation, one after the other or as a mixture. Examples of suitable initiator molecules include water, organic dicarboxylic acids such as succinic acid, adipic acid, phthalic acid and terephthalic acid, aliphatic and aromatic, optionally N-mono-, N,N-, and N,N′-dialkyl substituted diamines with 1 to 4 carbons in the alkyl radical, such as optionally mono- and dialkyl-substituted ethylenediamine, diethylenetriamine, triethylenetetramine, 1,3-propylenediamine, 1,3- and 1,4-butylenediamine, 1,2-, 1,3-, 1,4-, 1,5-, and 1,6-hexamethylenediamine, phenylenediamines, 2,3-, 2,4- and 2,6-toluenediamine and 4,4′-, 2,4′-, and 2,2′-diaminodiphenylmethane.

Suitable initiator molecules also include alkanolamines such as ethanolamine, diethanolamine, N-methyl- and N-ethyl ethanolamine, N-methyl- and N-ethyl diethanolamine and triethanolamine plus ammonia.

Divalent alcohols are preferred such as ethanediol, 1,2-propanediol and 1,3-propanediol, diethylene glycol, dipropylene glycol, 1,4-butanediol, and 1,6-hexanediol.

The polyether polyols have a functionality of preferably 1.9 to 2.1 and have a hydroxyl number of 30 to 200 mg KOH/g.

Like the polyester polyols, the polyether polyols may be used either individually or in the form of mixtures. Furthermore, they can be mixed with the polyester polyols as well as the polycarbonates, and/or polycaprolactone.

Suitable hydroxyl group-containing polycarbonates include those of the known type such as those obtained by reaction of diols, e.g., 1,3-propanediol, 1,4-butanediol, and/or 1,6-hexanediol, diethylene glycol, triethylene glycol or tetraethylene glycol and diaryl carbonates, e.g., diphenyl carbonate, or phosgene.

### Chain Extenders

The thermoplastic polyurethane is prepared using chain extenders. Suitable chain extenders include preferably diols. Typical examples are aliphatic, cycloaliphatic and/or araliphatic diols having 2 to 14, more preferably 4 to 10 carbon atoms such as ethylene glycol, 1,3-propanediol, 1,10-decanediol, o-, m-, p-dihydroxycyclohexane, diethylene glycol, dipropylene glycol, and preferably 1,4-butanediol, 1,6-hexanediol, and bis(2-hydroxyethyl)hydroquinone.

### Other Additives and Auxiliaries

Optionally other additives and/or auxiliaries may be incorporated into the thermoplastic polyurethane composition. Examples include antioxidants, UV stabilizers, lubricants, matting agents, nucleating agents, plasticizers, catalysts, crosslinkers, fillers, dyes, pigments, hydrolysis preventing agents, fungistatic and bacteriostatic agents. The kinds and/or dosage of the additives and auxiliaries may be determined according to the specific application where the thermoplastic polyurethane composition is used.

### Isocyanate Component

The isocyanate component in the present disclosure comprises one or more selected from the group consisting of aliphatic, cycloaliphatic, araliphatic, and aromatic isocyanates. For example, the isocyanate component may include alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate and preferably 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate as well as the corresponding isomeric mixtures, 4,4′, 2,2′-, and 2,4′-dicyclohexylmethane diisocyanate as well as the corresponding isomeric mixtures and preferably aromatic diisocyanates and polyisocyanates such as 2,4- and 2,6-toluene diisocyanate and the corresponding isomeric mixtures 4,4′-, 2,4′-, and 2,2′-diphenylmethane diisocyanate and the corresponding isomeric mixtures, mixtures of 4,4′- and 2,4′-diphenylmethane diisocyanates, as well as mixtures of polymeric MDI and toluene diisocyanates. The organic di- and polyisocyanates can be used individually or in the form of mixtures.

### Preparation

Preparation of thermoplastic polyurethane has been described elsewhere, but basically involves reaction of polyol and a chain extender with an isocyanate optionally in the presence of a catalyst.

The preparation of the thermoplastic polyurethane can be carried out by known methods, either batchwise or continuously, for example using reaction extruders or by the belt process by the one-shot process or the prepolymer process, preferably by the one-shot process.

### Processing

The thermoplastic polyurethane composition may be processed by conventional ways including injection molding, compression molding, extrusion, co-extrusion, thermoforming cast, sintering, vacuum molding, extrusion, co-extrusion, fused deposition modelling, fused filament fabrication, selective laser sintering, selective laser melting, powder bed fusion, sheet lamination, material extrusion, etc.

The thermoplastic polyurethane composition may be powder, flakes, rods, sheets, or blocks, or alternatively in the form of pellets or granules through e.g., strand cutting or underwater cutting.

### Applications

Various articles may be produced from the thermoplastic polyurethane composition according to the present disclosure. The articles include, inter alia, artificial leathers, films, sheets, moldings, fibers, trim in automobiles, tubes, hoses, profiles, pipelines, cable connectors, towing cables, cable sheathing, wires, optical components, electronic components, electrical components, seals, nonwovens, belts or damping elements.

These articles may find applications in an electric vehicle, or a charging device for electric vehicles, a home appliance, house or office furniture, a construction, an optical device, an electronic device, an electrical device, etc.

### EXAMPLES

### Measuring and Test Methods

The measuring and test methods are shown in Table 1.

TABLE 1
Measuring and test standards

| Property | Unit | Testing standard |
|---|---|---|
| Shore hardness | A | DIN ISO 48-4 |
| Tensile strength | MPa | DIN 53504 |
| Elongation at break | % | DIN 53504 |
| Tear strength (trouser) | kN/m | DIN ISO 34-1, (A) |
| Tear strength (angle) | kN/m | DIN ISO 34-1, B (b) |
| Abrasion loss | mm³ | DIN ISO 4649 |
| Flame retardancy | / | UL94 V, 2 mm |
| Dielectric strength | kV/mm | ASTM D149 |
| Volume resistivity | Ω · cm | IEC 62631-3-1: 2016 |
| Surface resistance | Ω | IEC 62631-3-2: 2015 |

### Materials

The following materials were used in the examples shown in Tables 2 and 3.
Elastollan® 1190A, a polyether based aromatic TPU from BASF Polyurethanes GmbH, tensile strength, 50 MPa; tear strength (angle), 89 kN/m; abrasion loss, 40 mm³.
CDP and RDP, from Zhejiang Wansheng Co., Ltd.
IL 1, an ionic liquid based on quaternary phosphonium cation and organophosphate anion, used as flame retardant.
Butanediol, from BASF, used as chain extender for synthesizing thermoplastic polyurethane of examples in Table 3.
Poly(tetrahydrofuran ether), functionality 2, hydroxyl value 112.2 mgKOH/g, from BASF, used as polyol for synthesizing thermoplastic polyurethane of examples in Table 3.
Lupranate® MS, mainly 4,4′-MDI, from BASF, used as isocyanate for synthesizing thermoplastic polyurethane of examples in Table 3.
Polystyrene-based matting agent.
Antioxidant Irganox® 1010, a sterically hindered phenol from BASF.

To prepare flame-retardant thermoplastic polyurethane composition, the two flame retardants were added into the thermoplastic polyurethane. The ionic liquid and the phosphorus-containing ester were added into the thermoplastic polyurethane separately, then they were dispersed evenly. The mixture was heated under 80 °C for several hours until the liquids were evenly dissolved into the matrix of thermoplastic polyurethane.

The resultant flame-retardant thermoplastic polyurethane composition was shaped into testing sheets with a thickness of 2 mm via injection molding for mechanical performance and flame-retardancy testing.

Table 2 shows examples with a UL94 V0 level of flame retardancy, while Table 3 shows examples with a UL94 V2 level.

TABLE 2
Properties of thermoplastic polyurethane compositions

| | | | | | | | |
|---|---|---|---|---|---|---|---|
| TPU Examples | 1 | 2 | 3 | 4 | 5 | 6 | 7 |

Formulation

| | | | | | | | |
|---|---|---|---|---|---|---|---|
| Elastollan ® 1190A, wt. % | 80 | 84.7 | 89.5 | 91.8 | 94 | 95.5 | 97 |
| IL 1, wt. % | 0 | 0.3 | 0.5 | 0.7 | 1 | 1.5 | 3 |
| CDP, wt. % | 20 | 15 | 10 | 7.5 | 5 | 3 | 0 |

Performance

| | | | | | | | |
|---|---|---|---|---|---|---|---|
| Shore hardness, A | 82 | 84 | 85 | 86 | 87 | 88 | 88 |
| Tensile strength, MPa | 40 | 43 | 45 | 45 | 44 | 45 | 44 |
| Elongation at break, % | 695 | 676 | 662 | 599 | 598 | 602 | 599 |
| Tear strength (trouser), kN/m | 38 | 45 | 50 | 51 | 54 | 63 | 67 |
| Tear strength (angle), kN/m | 49 | 61 | 67 | 73 | 75 | 78 | 92 |
| Abrasion loss, mm³ | 50 | 45 | 32 | 32 | 34 | 40 | 44 |
| Flame retardancy, UL94 | V0 | V0 | V0 | V0 | V0 | V0 | V0 |
| Dielectric strength, kV/mm | 16.4 | 7.4 | 7.7 | 8.1 | 8.1 | 7.1 | 6.1 |
| Volume resistivity, 10⁹ Ω · cm | 2,000 | 11 | 13 | 20 | 23 | 11 | 6.5 |
| Surface resistance, 10⁹ Ω | 1,800 | 30 | 43 | 84 | 69 | 83 | 19 |

From Table 2, it is indicated that compared with TPU compositions with only phosphorus-containing ester as flame retardant, TPU compositions with both ionic liquid and phosphorus-containing ester as co-flame retardant can achieve the same level of flame-retardancy under a much lower dosage. To achieve the roughly same level of flame retardancy, the TPU composition with both ionic liquid and phosphorus-containing ester exhibits improvements with regards to mechanical performances especially tear strength and abrasion loss. Abrasion loss and tear strength important for products such as cable sheathing, wire, hose, pipeline, belt, etc. To achieve good mechanical performances, the weight percentage of ionic liquid is preferably 0.2-2.8 wt. %, 0.3-1.5 wt. %, more preferably 0.5-1.0 wt. %, based on the total weight of the thermoplastic polyurethane composition. Compared with the original thermoplastic polyurethane Elastollan® 1190A, the flame-retardant thermoplastic polyurethane with ionic liquid and phosphorus-containing ester deteriorates less in tensile strength, tear strength and abrasion loss.

TABLE 3
Properties of thermoplastic polyurethane compositions

| | | | | |
|---|---|---|---|---|
| TPU examples | 8 | 9 | 10 | 11 |

Formulation

| | | | | |
|---|---|---|---|---|
| TPU, wt. % | 72 | 80.5 | 82.5 | 84 |
| IL 1, wt. % | 0 | 0.5 | 0.5 | 2 |
| CDP, wt. % | 14 | 5 | 0 | 0 |
| RDP, wt. % | 0 | 0 | 3 | 0 |
| Matting agent, wt. % | 13 | 13 | 13 | 13 |
| Antioxidant, wt. % | 1 | 1 | 1 | 1 |

Performance

| | | | | |
|---|---|---|---|---|
| Shore hardness, A | 80 | 80 | 80 | 80 |
| Tensile strength, MPa | 36 | 39 | 41 | 40 |
| Elongation at break, % | 580 | 630 | 615 | 650 |
| Tear strength (trouser), kN/m | 35 | 46 | 45 | 48 |
| Abrasion loss, mm³ | 45 | 39 | 38 | 40 |
| Flame retardancy, UL94 | V2 | V2 | V2 | V2 |

TPUs in Table 3 were synthesized via an extruder. The isocyanate index calculated as the ratio of the number of isocyanate groups in polyisocyanate to the total number of hydroxyl groups in chain extender and polyol was about 1. The flame retardants, matting agent, and antioxidant were added to the thermoplastic polyurethane during its synthesis.

From Table 3, it can be found that TPU compositions with both ionic liquid and phosphorus-containing ester as co-flame retardant can achieve the same level of flame-retardancy with a much lower dosage and under the presence of other additives. The thermoplastic polyurethane sample with ionic liquid and phosphorus-containing ester outperforms those samples containing only phosphorus-containing ester as flame-retardant in terms of mechanical strength, elongation at break, and abrasion loss.

1. A thermoplastic polyurethane composition comprising, based on a total weight of the thermoplastic polyurethane composition,
84-97 wt. % of a thermoplastic polyurethane, and
3-16 wt. % of a flame retardant,
wherein the flame retardant comprises an ionic liquid and a phosphorus-containing ester.

2. The thermoplastic polyurethane composition according to claim 1, wherein the ionic liquid is a phosphorus-based ionic liquid.

3. The thermoplastic polyurethane composition according to claim 2, wherein the phosphorus-based ionic liquid has a formula of: 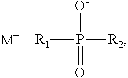
in which M⁺ represents a monovalent cation selected from the group consisting of an ammonium, a quaternary ammonium, an imidazolium, a guanidinium, a pyridinium, a pyridazinium, 1,2,4-triazolium, a triazine, a sulfonium, a phosphazenium and a phosphonium cation; and
R₁ and R₂ are each independently selected from hydrogen, hydroxyl, C1-C18 alkyl, aryl, C1-C18 alkoxyl, aryl, (C3-C10) heterocyclyl, (C3-C10)cycloalkyl, (C3-C10)heterocyclyl (C1-C8)alkyl, aryl (C1-C8)alkyl, heteroaryl and heteroaryl (C1-C8)alkyl group, each of which is unsubstituted or substituted with one or two halogen atoms, —NO₂, —CF₃, —OCF₃, —OCH₃, —CO₂H, —NH₂, —OH, —SH, —NHCH₃, —N(CH₃)₂, —CN, —SCH₃, —SO₃H, —CH═CH—CH—CH═CH₂, —P((C1-C5) alkyl)₂, and —P(O)(OEt)₂, or mixtures thereof.

4. The thermoplastic polyurethane composition according to claim 3, wherein M⁺ represents a phosphonium cation.

5. The thermoplastic polyurethane composition according to claim 1, wherein the ionic liquid has a weight percentage of 0.2-2.8 wt. % based on a total weight of the thermoplastic polyurethane composition.

6. The thermoplastic polyurethane composition according to claim 1, wherein the phosphorus-containing ester includes one or more selected from resorcinol bis(diphenylphosphate), bisphenol A bis(diphenyl phosphate), cresyl diphenyl phosphate, monomeric resorcinol dixylenyl phosphate, polymeric resorcinol dixylenyl phosphate, trixylenyl phosphate, triethyl phosphate, tricresyl phosphate, and triphenyl phosphate.

7. The thermoplastic polyurethane composition according to claim 1, wherein the phosphorus-containing ester has a weight percentage of 1-18 wt. % based on a total weight of the thermoplastic polyurethane composition.

8. The thermoplastic polyurethane composition according to claim 1, wherein the ionic liquid and the phosphorus-containing ester are present in a weight ratio of 1:100-1:0.7.

9. The thermoplastic polyurethane composition according to claim 1, wherein the thermoplastic polyurethane has a weight average molecular weight in the range from 50,000 to 500,000 Da.

10. The thermoplastic polyurethane composition according to claim 1, wherein the thermoplastic polyurethane composition has a hardness of Shore 40 A to Shore 80 D as determined in accordance with DIN ISO 48-4.

11. The thermoplastic polyurethane composition according to claim 1, wherein a sheet of a thickness of 2 mm prepared from the thermoplastic polyurethane composition achieves a UL94 V0 rating, following procedures of Underwriter's Laboratory Bulletin 94 entitled “Tests for Flammability of Plastic Materials, UL94”.

12. An article, comprising the thermoplastic polyurethane composition according to claim 1.

13. The article according to claim 12, wherein the article is an artificial leather, a film, a sheet, a molding, a fiber, a trim in automobiles, a tube, a hose, a profile, a pipeline, a cable connector, a towing cable, a cable sheathing, a wire, an optical component, an electronic component, an electrical component, a seal, a nonwoven, a belt, or a damping element.

14. The article according to claim 12, wherein said article is a part of, or is present in, an electric vehicle, a charging device for electric vehicles, a home appliance, a house, office furniture, an optical device, an electronic device, or an electrical device.
